(19) United States
(12) Patent Application Publication
(10) Pub. No.: US 2026/0220090 A1
(43) Pub. Date: Jul. 30, 2026

(54) LOG STORAGE MANAGEMENT

(71) Applicant: Elastic Technologies (US) Inc., Wilmington, DE (US)

(72) Inventors: Martijn van Groningen, Hoofddorp (NL); Duy Nhat Nguyen, San Jose, CA (US); Oleksandr Kolomiiets, Coquitlam (CA); Salvatore Campagna, Turin (IT)

(21) Appl. No.: 19/461,432

(22) Filed: Jan. 27, 2026

Related U.S. Application Data
(60) Provisional application No. 63/749,964, filed on Jan. 27, 2025.

(51) Int. Cl. G06F 16/174; G06F 16/14; G06F 16/16

(52) U.S. Cl. CPC G06F 16/1744; G06F 16/156; G06F 16/162

(57) ABSTRACT

According to at least one implementation, a method includes obtaining a plurality of logs from a plurality of computing devices. The method further includes indexing the plurality of logs based on timestamps associated with the plurality of logs and host identifiers associated with the plurality of logs, and performing compression on the indexed plurality of logs.

### CROSS-REFERENCE TO RELATED APPLICATION

This application claims the benefit of U.S. Provisional Application No. 63/749,964, filed January 27, 2025, the disclosure of which is incorporated herein by reference in its entirety.

### BACKGROUND

In computing environments with multiple systems and devices, logs are routinely generated by a wide range of components. These components can include servers, desktop computers, laptop computers, virtual machines, containers, network devices, and software applications executing on those devices. Logs are created as part of normal system operation and record events such as system startups and shutdowns, application execution, configuration changes, user activity, network communications, and error conditions. Each device or application may generate logs independently, producing a continuous record of activity over time.

Logs typically include information that identifies when an event occurred and where it originated, along with descriptive details about the event itself. Common log contents include timestamps, host identifiers, process or application names, status codes, error messages, and other contextual data associated with system behavior. This information provides a historical record of actions and events occurring across the computing environment. By collecting logs from many devices and systems, an organization can maintain visibility into operational activity, system interactions, and the overall behavior of complex, distributed computing environments.

### SUMMARY

Described herein are systems and methods for efficiently storing and searching computer log data. Logs are records generated by computers and servers that describe events such as system activity, errors, or user actions. The system receives logs from multiple computing devices and first organizes, or indexes, the logs based on when each log occurred (i.e., timestamp) and which device created it (i.e., host identifier or hostname). After the logs are indexed, the system can perform compression. Indexing logs before compression can group similar entries, allowing the compression process to reduce storage size more effectively.

In some implementations, the system may not maintain the original log files. Instead, the system can be configured to identify specific fields within each log, such as timestamps, hostnames, IP addresses, or error codes, and store those fields in compressed formats. Different fields may be compressed using different techniques depending on the data type. Once these fields are stored, the original logs may be deleted to preserve storage space. When a user later submits a query or requests a log, the system uses the index to locate the relevant compressed data and can recreate the requested log information from the stored fields. This approach reduces storage requirements while still allowing efficient searching and retrieval of log data.

In some aspects, the techniques described herein relate to a method including: obtaining a plurality of logs from a plurality of computing devices; indexing the plurality of logs based on timestamps associated with the plurality of logs and host identifiers associated with the plurality of logs; and performing compression on the indexed plurality of logs.

In some aspects, the techniques described herein relate to a computing system including: at least one processor; a computer-readable storage medium operatively coupled to the at least one processor; and program instructions stored on the computer-readable storage medium that, when executed by the at least one processor, direct the computing system to perform a method, the method including: obtaining a plurality of logs from a plurality of computing devices; indexing the plurality of logs based on timestamps associated with the plurality of logs and host identifiers associated with the plurality of logs; and performing compression on the indexed plurality of logs.

In some aspects, the techniques described herein relate to a computer-readable storage medium having program instructions stored thereon that, when executed by at least one processor, direct the at least one processor to perform a method, the method including: obtaining a plurality of logs from a plurality of computing devices; indexing the plurality of logs based on timestamps associated with the plurality of logs and host identifiers associated with the plurality of logs; and performing compression on the indexed plurality of logs.

The accompanying drawings and the description below outline the details of one or more implementations. Other features will be apparent from the description, drawings, and claims.

### BRIEF DESCRIPTION OF THE DRAWINGS

FIG. 1 illustrates a computing environment that manages the storage of logs from computing devices according to an implementation.

FIG. 2 illustrates a method of operating a computing system to compress logs in a computing environment according to an implementation.

FIG. 3 illustrates an operational scenario for compressing logs according to an implementation.

FIG. 4 illustrates an operational scenario of processing log queries according to an implementation.

FIG. 5 illustrates a method of providing responses to log queries according to an implementation.

FIG. 6 illustrates a computing system to manage log storage according to an implementation.

### DETAILED DESCRIPTION

In computing environments, logs can record events, processes, or activities within a system, application, or network. Logs can capture information, such as timestamps, user actions, error messages, security incidents, or status updates, helping administrators monitor system health, troubleshoot issues, and ensure security compliance. Logs can be stored in files or databases, which can be structured to make it easier to review and analyze. By examining logs, administrators can detect patterns, diagnose failures, trace unauthorized access, and improve overall system performance and security. However, at least one technical problem exists in efficiently storing logs from computing devices to reduce storage requirements and facilitate searching across logs.

In some implementations, a computing environment can employ compression to reduce the size of various data objects (e.g., logs, files, images), thereby saving storage space, optimizing bandwidth usage, and speeding up data transfer. Compression reduces data redundancy, making the data smaller while preserving essential information, which can be helpful for files, images, videos, application data, and other data objects. For example, compressing files allows faster uploads and downloads over the internet, reduces storage costs, and can improve application performance by minimizing the amount of data that needs to be read, written, or transferred. Decompression restores the data to its original form when needed, balancing efficiency and accessibility. However, at least one technical problem with compression is compressing the data based on the specific object or file type requirements.

In at least one technical solution, a computing system can be configured to index logs received from a set of computing devices before compressing and storing the information from the logs. Indexing the logs before compression can reduce the final size of a compressed database by organizing data more efficiently and minimizing redundancy. Indexing involves creating a systematic structure of the data, identifying and categorizing unique data elements, and replacing repeated patterns with references or pointers. This approach allows the compression algorithm to operate on a simpler, streamlined data set, reducing the amount of redundant information it must process. By indexing before compression, the database can reduce duplicate entries and prioritize common data elements, resulting in a smaller, faster, and more optimized set of compressed logs.

In some implementations, the computing system managing log storage can be configured to index received logs based on the host identifier (i.e., hostname) and the timestamp associated with each log. A hostname is a unique label assigned to a device on a network that identifies the device to other devices on that network. A hostname can be used in network communications to locate and access specific devices, like computers or servers. For example, a computing system can be configured to store the logs associated with a plurality of servers on a network. The computing system can receive logs from each server and index the incoming logs before compressing the files. Indexing the logs based on hostname and timestamp includes creating a structured reference where log entries are organized by the device (hostname) that generated them and the time (timestamp) they occurred. Indexing logs by hostname and timestamp before compression can reduce data redundancy and enhance searchability within the compressed files. By first organizing logs in this structured way, duplicate entries and common patterns can be more easily identified, allowing the compression algorithm to work more efficiently and produce a smaller end data structure for the logs. This pre-compression indexing can also enable faster access to specific logs after decompression, as the index provides a map of data locations, improving both storage efficiency and data retrieval performance in large or complex log datasets.

In some implementations, the original document is not stored directly in the index when the computing system compresses the document. Instead, the computing system indexes the fields needed for search and stores only specific fields or metadata (e.g., fields separate from the indexed fields, such as IP address, error code, and the like), using the mappings to reconstruct the document when queried. This compression operation can reduce storage size because the original document is not retained. Rather, the necessary information, like selected fields or values, is stored in a compressed form. When a query requests the document, the computing system dynamically rebuilds the original document (or a portion of the original document) by combining stored fields and applying mapping rules, effectively compressing the data without losing searchable elements. In some cases, different fields and metadata can be stored using various codecs, such as dictionaries, offset encoding, and delta encoding. The codec for each field or metadata item can be selected based on the data being stored, with one codec offering greater efficiency than another. As a technical effect, the required fields and metadata are maintained while reducing the overall storage footprint of the log data.

In some technical solutions, a computing system can be configured to receive logs from multiple hosts operating within a shared or distributed computing environment, such as a data center, cloud infrastructure, or hybrid network. Each host, identified by a host identifier such as a hostname, can generate logs independently based on its local operations, applications, and system events. These logs may be transmitted to the computing system over a network using periodic uploads, streaming delivery, or event-driven transfers. The computing system can accept logs from heterogeneous hosts, including physical servers, virtual machines, containers, and application instances, and normalize the incoming data so that logs from different sources can be processed using a common ingestion and storage pipeline. In some implementations, log normalization is performed during ingestion by applying parsing and transformation rules to incoming log data from different source systems. These rules extract relevant values from source-specific formats and map them to a common set of standardized fields, such as timestamps, host identifiers, severity levels, and the like. By supporting concurrent log delivery from multiple hosts, the system enables centralized visibility into distributed operations while preserving the association between each log entry and the host.

In some implementations, as the logs are received, the computing system can be configured to perform indexing operations based on timestamps and host identifiers associated with each log entry. As used herein, indexing refers to extracting selected fields from the log data and organizing the fields into a structured reference that maps log entries according to defined dimensions. A host identifier, such as a hostname, uniquely identifies the computing device that generated a log, while a timestamp is a temporal value indicating when the logged event occurred. During the indexing operation, the computing system parses each incoming log to identify these fields and records them in an index structure that associates each log entry with its originating host and its time of occurrence. This process establishes an ordered, source-aware representation of the logs without requiring the system to retain the full original log document in the index.

The indexing operations produce several technical effects that improve the handling of large volumes of log data. By organizing logs by host identifier and timestamp, the computing system groups related log entries from the same computing device and within similar time ranges, improving data locality within the index. This organization reduces fragmentation caused by log arrival from multiple hosts and provides a consistent ordering of events. As a result, the indexed structure enables more efficient navigation of the log data, allowing the system to quickly identify subsets of logs associated with a particular host and/or time window. These effects improve scalability and performance by limiting unnecessary processing of unrelated log entries and by establishing a structured foundation for subsequent storage and retrieval operations.

For example, a computing environment can include three different hosts. As logs are received from a first server, a second server, and a third server, the computing system can index each log by extracting the host identifier and timestamp from the log entry. The first server may generate logs related to application execution, such as service start events, request handling messages, and error codes. The second server may produce network activity logs, including connection attempts, IP addresses, and authentication results, while the third server may generate system-level logs detailing resource usage, configuration changes, or software updates. As each log arrives, the computing system records the hostname identifying the server that generated the log and the timestamp indicating when the event occurred. The index then organizes the logs so that entries from each server are grouped together and ordered by time, allowing the computing system to maintain a clear, source-aware, and time-ordered view of events across the three servers despite the logs being received in an interleaved manner.

Following indexing, compression operations can be applied to the indexed log structures to reduce storage size while maintaining reconstruction and query correctness. In this stage, compression is defined as a set of encoding transformations applied to indexed data blocks that reduce entropy by exploiting repetition, ordering, and constrained value ranges introduced during indexing. Rather than operating on raw log files, the compression layer consumes normalized, segmented field data, enabling block-based and field-specific codecs. Because indexed logs are already grouped by shared schema and temporal proximity, compression algorithms can identify repeated byte sequences, stable field values, and predictable numeric progressions with greater efficiency than in unindexed streams.

In some implementations, a primary compression operation applied after indexing can be field-level encoding, in which each indexed field is compressed independently using a codec selected based on the data type and statistical properties of that field. For example, low-cardinality string fields such as host identifiers, service names, or severity levels may be compressed using dictionary encoding, where unique values are stored once and subsequent occurrences are replaced with compact integer references. Numeric fields, including timestamps and counters, may be compressed using delta encoding, which stores the difference between consecutive values, or offset and frame-of-reference encoding, which store values relative to a shared base. These operations reduce the bit width required to represent each value and are particularly effective because indexing enforces ordering and co-location of similar values.

In addition to field-specific encodings, compression operations may include segment-level block compression applied across contiguous indexed records. In some examples, after field encoding, compressed field blocks can be processed using general-purpose compression algorithms that identify repeated byte patterns across multiple records, such as recurring log templates or structured metadata layouts. These block compressors replace repeated sequences with back-references into sliding or static dictionaries, further reducing storage size. Because indexing aligns records with similar structure and content into the same segments, the probability of repeated sequences is increased, directly improving compression ratios and reducing storage overhead.

In some implementations, compression operations intentionally exclude storage of the original log document or source payload. Instead, only compressed field values and associated mappings are retained. This operation eliminates redundancy associated with storing both indexed fields and raw source data. When retrieval is required, the system reconstructs a logical representation of the log entry by decoding the compressed fields and applying stored mappings. From a technical standpoint, this compression strategy reduces persistent storage requirements while preserving the ability to regenerate log records with semantic fidelity, enabling scalable retention of high-volume log data streams without proportional growth in storage consumption.

As an illustrative example of the compression operations, when a log is received from a server, the log can be parsed, if necessary, into a structured format so individual fields such as timestamp, host identifier, log level, and message can be processed independently. Repeating values across many logs, such as the same hostname or service name, can be identified and compressed using dictionary encoding, where each unique value is stored once and later referenced by a small identifier. Numeric fields that change gradually, such as timestamps, can be compressed with delta encoding, storing only the difference from the previous value rather than the full value.

After these field-level reductions, the processed log data can be grouped into small blocks or segments and compressed using a lightweight stream-oriented algorithm. Each block is compressed independently, so that the block can be decompressed on demand during search or analysis without expanding all stored logs. This block-based compression minimizes storage usage while still supporting fast ingestion and efficient retrieval of server log data.

In some implementations, grouping log data into blocks or segments enables the computing system to reduce the log records into fixed-size blocks (e.g., 16 KB or a few thousand records) and treat each block as an independent compression unit. The reduced fields, when represented as compact integers, deltas, or short tokens, are serialized into a continuous byte stream in a consistent order, which increases the likelihood that similar byte patterns appear close together. A fast block-level compression algorithm can then scan this byte stream using a sliding window to detect repeated byte sequences across multiple log entries within the same

block and replace those sequences with short references that point backward to earlier occurrences. For example, if several log records in a block share the same encoded field layout and similar token patterns, the compressor may store the first instance fully and encode subsequent instances as references, such as copying a first set of bytes from a set of earlier bytes. The compressed output for the block includes both the compressed data and minimal metadata describing block boundaries, allowing the system to later decompress only that block without touching others. This block-based approach can balance speed and compression efficiency while enabling random access during queries.

In some implementations, once the logs are compressed and stored, a user can generate a query to the logs. In some examples, the query is received by a log storage computing system that executes the query using a pre-compression index, generated on host identifiers (e.g., hostnames) and timestamps, to identify a targeted subset of compressed log data without scanning or decompressing the entire data store, where the index functions as a structured reference mapping host-and-time predicates to physical storage locations. Based on this mapping, the system can perform selective decompression of only the compressed segments associated with the relevant host and time range, decodes any stored fields or metadata (e.g., IP address, error code) that were compressed using field-specific codecs such as dictionary, delta, or offset encoding, and, in implementations using a synthetic source model, dynamically reconstructs the original log document or requested portion thereof using stored mappings rather than retrieving a fully stored original file. This can reduce the storage overhead while preserving query functionality. For example, a query to select logs with a specific host name between a first time and a second time with a specific error code can be resolved by first locating the indexed hostname and timestamp range, then selectively decompressing and reconstructing only the matching log entries to generate a response based on both the compression and indexing of the logs, which has the technical effect of minimizing computational overhead and improving query response time in large-scale log datasets.

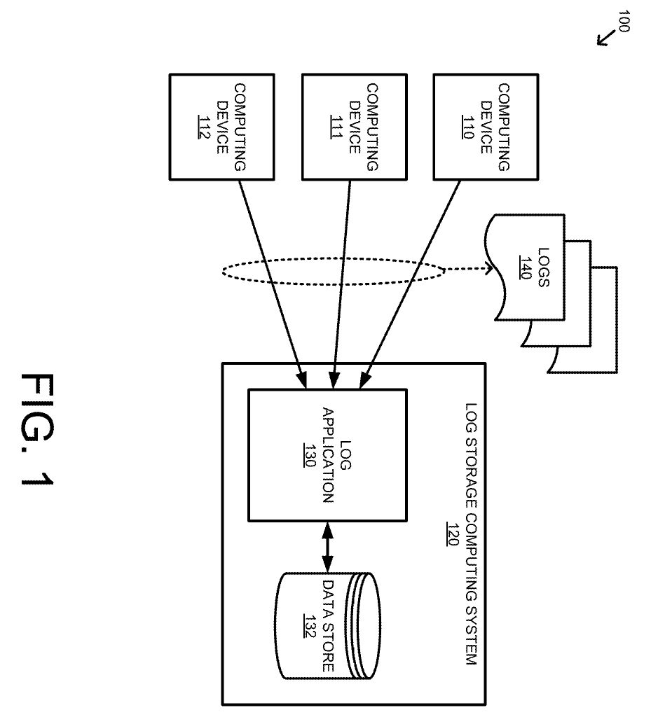

FIG. 1 illustrates a computing environment 100 for managing the storage of logs from computing devices according to an implementation. Computing environment 100 includes computing devices 110-112, log storage computing system 120, and logs 140. Log storage computing system 120 includes log application 130 and data store 132. Log storage computing system 120 can be implemented on one or more computing devices, such as servers, desktop computers, or some other computing devices.

In computing environment 100, computing devices 110-112 are representative of servers, desktop computers, or some other computing device in a network. Computing devices 110-112 generate logs 140. Logs 140 are files or records that track events, operations, or interactions within a computer system or application over time. They capture information like timestamps, user actions, system errors, network requests, and security events, enabling administrators to monitor activity, troubleshoot issues, and analyze system performance. Logs can be created by the operating system, applications, or services, ranging from basic event details to extensive technical data. For example, logging can occur during software updates. When a server applies a security patch or updates an application, it can generate logs documenting the steps of the update process. These logs might include timestamps for when the update started and completed, details of modified files and configurations, and any issues or errors encountered during the process. For example, suppose something goes wrong during the update, like a file failing to update correctly or a service not restarting. In that case, an administrator can refer to these logs to diagnose the problem and ensure the server’s software is up to date and functioning as expected.

In the example of computing environment 100, computing devices 110-112 communicate the logs to log storage computing system 120. Log storage computing system 120 provides log application 130 that stores compressed logs in data store 132. In compressing the logs, log application 130 first indexes the logs based on the hostname (i.e., host identifier) and timestamp associated with each of the logs. Indexing logs by hostname and timestamp organizes log data to make it easier to search and analyze, recording the specific server or machine (hostname) and the time of each log entry (timestamp). Hostnames identify which computer or device generated each log, which is used in environments with multiple systems, as it allows tracking issues back to their source. Timestamps, which record the time of each event, enable chronological sorting, making it easier to trace event sequences, detect patterns, and diagnose problems. Log storage computing system 120 can collocate logs that frequently share similar attributes or information by indexing using hostname and timestamp.

In some examples, log storage computing system 120 can determine the hostname and timestamp by extracting them directly from each log record when those fields are explicitly included in the log payload (e.g., an application-generated or OS-generated hostname field and event timestamp), and in other implementations the system derives the hostname from the source computing device or network metadata associated with log ingestion while assigning a timestamp at ingest time if the log does not already include one, where an ingest-time timestamp represents the time the log was received or processed by the log storage computing system. These values can then be normalized and associated with each log entry prior to indexing, so they can be used as primary index keys for organizing, compressing, and later querying the logs, ensuring that all logs are searchable by host identifier and time, even when the original log data omits one or both fields.

After indexing the logs, log storage computing system 120 compresses the logs in data store 132. Indexing files before compression can reduce storage requirements by organizing data to improve compression efficiency. When logs are indexed by hostname and timestamp, similar or redundant information can be grouped, which compression algorithms can use to achieve higher compression ratios. For instance, logs from the same host or in close time proximity may have similar patterns and repetitive content, such as recurring events or structured data, making them more compressible. Additionally, indexing can assist with deduplication, identifying and eliminating redundant entries before compression, further reducing storage requirements.

In some implementations, after indexing, compression operations may include field-level compression, in which the individual fields of each log entry are compressed based on their data types. In this step, the system parses each log line into fields (e.g., hostname, timestamp, IP address, error code, and/or message) and applies specialized encodings to reduce redundancy. As a concrete example, repeated hostname values like “server-110” are stored once in a dictionary and replaced with a small numeric identifier throughout the logs, while timestamps such as “10:00:01,” “10:00:03,” and “10:00:05” are stored using delta encoding so that only the first timestamp is stored in full and the rest are stored as small time differences. For example, +2 seconds. In this example, full-field values are replaced with compact numeric or offset representations, significantly reducing the raw log data size.

Additionally, once field-level compression has been applied, log storage computing system 120 can use general-purpose pattern compression on the already-compressed field data. This second layer of compression operates on the encoded output and determines repeated byte patterns across multiple log entries or within log blocks. For example, after hostnames and timestamps are replaced with small numeric values, the remaining encoded log structure may contain repeated sequences that represent common error codes, message templates, or field layouts. The general-purpose compressor stores these repeated sequences once and replaces subsequent occurrences with short references. In this process, repeated encoded patterns, not the original text, are what get replaced, allowing the system to further reduce storage size without losing the ability to reconstruct the original logs.

In some implementations, the system also applies selective field storage with synthetic reconstruction as part of or after the compression process. Instead of storing the entire original log record, log storage computing system 120 indexes only the fields required for searching, such as hostname and timestamp. Log storage computing system 120 then stores other fields, such as IP addresses or error codes, in compressed form, and omits or partially stores large message fields. For example, rather than storing a full JSON log entry, the system may store compressed field values and mapping information that describes how to reassemble the log. When a query requests a log entry, the system reconstructs the original log or a portion of it by combining the indexed keys with the compressed field data. In this example, large portions of the log are compressed and reconstructed using reconstruction rules.

Once the logs are indexed and stored, the logs can be reassembled to support different queries to the logs, where a query is first evaluated against an index generated during ingestion to identify relevant host identifiers and timestamp ranges and to locate corresponding compressed data blocks without scanning the entire data store. In response to the query, the system consults the index to determine which compressed segments may contain matching log entries, then selectively decompresses only those segments, thereby reducing I/O operations and computational overhead. This targeted access allows the system to efficiently retrieve candidate log data based on query predicates such as hostname, time range, or other indexed attributes, rather than decompressing all stored logs.

After identifying and decompressing the relevant segments, the system reassembles individual log entries by decoding stored field values and applying predefined mappings used during compression. For example, hostname and timestamp values may be obtained directly from the index, while other fields, such as IP address or error code, are decoded from compressed field-level storage, and message content may be reconstructed from stored templates and variable values. The system then combines the indexed fields with the decoded fields to regenerate the original log entry or a requested portion thereof for presentation in the query response.

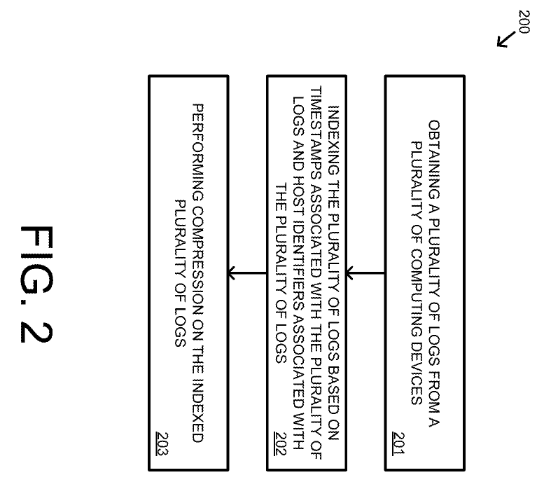

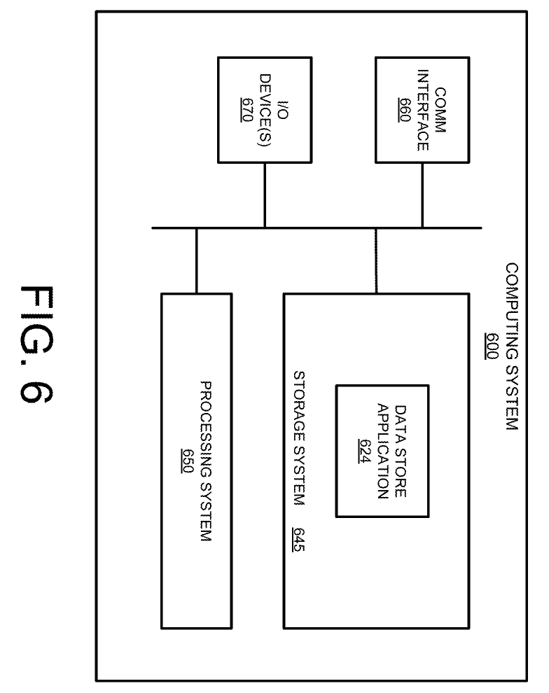

FIG. 2 illustrates a method 200 of operating a computing system to compress logs in a computing environment according to an implementation. The steps of method 200 are referenced parenthetically in the paragraphs that follow with reference to systems and elements of computing environment 100 of FIG. 1. Method 200 can be performed by a computing system, such as log storage computing system 120 of FIG. 1 or computing system 600 of FIG. 6. The computing system can include one or more computing devices, such as desktop computers, server computers, and the like.

Method 200 includes obtaining (201) a plurality of logs from a plurality of computing devices. Logs for computing devices are records that capture detailed information about the events, actions, and status changes occurring within the devices and across the network. These logs can include timestamps, IP addresses, error messages, authentication attempts, data transfers, and system diagnostics, providing a historical record of device and network activity. The logs can be collected from various computing devices, including servers, desktop computers, laptop computers, or other computing devices. The logs can be provided periodically, during downtime for the computing device, at the request of log storage computing system 120, or at some other interval. For example, computing device 110 can represent a server that generates logs and periodically communicates the logs to log storage computing system 120 for storage.

As used herein, a log is a structured or semi-structured record generated by a computing system, application, or network component that captures information about events or state changes, typically including a timestamp, source identifier, and event-specific data, for the purpose of monitoring, debugging, auditing, or analysis. In technical systems implemented with distributed logging and observability platforms, logs serve as append-only event streams that provide a chronological history of system behavior.

Method 200 further includes indexing (202) the plurality of logs based on timestamps associated with the plurality of logs and host identifiers associated with plurality of logs. In some implementations, the host identifiers comprise hostnames. Once indexed, method 200 further includes performing (203) compression on the indexed plurality of logs. Indexing logs by hostnames and timestamps before compression can reduce storage requirements by enabling more efficient compression algorithms. When logs are indexed by hostname and time, similar log entries from the same device or within close timeframes are grouped, increasing data redundancy and compressibility. In some examples, the compression algorithms can be improved by increasing the likelihood of repetitive patterns, which leads to improved compression ratios. Further, indexing allows selective decompression in some implementations, meaning only relevant sections are decompressed for queries, reducing the need for multiple copies or excessive storage overhead for frequently accessed data.

For example, when logs 140 are received from computing devices 110-112, log storage computing system 120 indexes the logs based on the host identifier (i.e., hostname) and timestamp. The indexing permits logs with similar attributes to be grouped, which improves the compression efficiency and overall size of data store 132. The compression can include Gzip (DEFLATE), Bzip2, LZ4, ZStandard, or some other standard. In some examples, the compression algorithm functions by identifying repeated data sequences and encoding them as references to earlier instances instead of storing the data again. The algorithm can use a dictionary-based approach, which recognizes patterns in the input and replaces them with pointers to previous occurrences, thereby reducing file size. In some examples, the system can use other types of encoding, such as delta encoding that stores the difference between consecutive values instead of the actual values, offset encoding that stores the difference from a base value rather than between consecutive values, Greatest Common Divisor (GCD) encoding that finds the greatest common divisor of a set of values and stores the differences as multiples of the GCD, Frame of Reference (FOR) encoding that determines the smallest number of bits required to encode a block of values and uses bit-packing to fit such values into larger 64-bit blocks, or some other encoding mechanism. By indexing the files first, the compression can be made more efficient (i.e., reduced storage space) by grouping similar data. As at least one technical effect, the reduced storage space for the logs and the indexing of the logs can permit faster query responses by limiting the amount of data that is processed for the query.

In at least one implementation, as part of the compression process, the logs are not stored in the data store of the log storage computing system. The compression process can involve selectively storing and indexing specific document fields while omitting or partially storing other data to save storage space. Instead of keeping the original, the system uses mappings to index searchable fields and stores selected fields in a compressed format for retrieval. At query time, the synthetic source dynamically reconstructs the document (or a portion of the document) using the stored and indexed data, simulating the original document without physically retaining its entirety. This approach reduces storage requirements while maintaining query and retrieval functionality. For example, a log can be indexed by its timestamp and hostname. Additionally, one or more other fields, such as IP addresses, error codes, and the like, can be stored in a compressed format and not indexed. When a query is received that returns the log, the log can be reassembled using the indexed fields and one or more additional fields compressed in one or more data structures.

In some implementations, each field can be encoded using any of the codecs mentioned above, including dictionaries, GCD encoding, offset encoding, and the like. The choice of codecs for each of the fields can be determined based on the data that is being encoded. For example, for a first field in a log, a first codec can be used, while for a second field in the log, a second codec can be used. When a log is required, the values are obtained, and the original log is generated. As at least one technical effect, because the logs are first indexed, similar values can be identified, and the compression can be more effective in reducing the size of the overall data structure.

In some implementations, the system (i.e., log storage computing system 120) can perform general-purpose compression in addition to the field-specific compression. As used herein, field-specific compression refers to compressing individual log fields separately using techniques selected based on the data characteristics of each field, such as dictionary encoding for repeated string values or delta encoding for ordered numeric values. General compression refers to applying a block-level or stream-level compression algorithm to a collection of encoded log data, rather than to individual fields in isolation. This general compression operates on the serialized output from the field-specific encodings and reduces redundancy by identifying repeated byte patterns across multiple log entries or within contiguous blocks of stored data.

In operation, once logs have been indexed and individual fields have been compressed, the resulting encoded fields are arranged into blocks or segments of data. These blocks may then be processed by a general compression algorithm that replaces recurring byte sequences with shorter references, thereby reducing the total number of bits required to store the data. For example, host identifiers may first be compressed using dictionary encoding, and timestamps may be compressed using delta encoding. The encoded values for multiple log entries are then written to a data block in a consistent order. Because many log entries share similar structures, encoded field layouts, and recurring values, the block contains repeated byte sequences that can be efficiently compressed using general compression. The compressed block is stored along with minimal metadata needed for decompression. When a query is received, only the relevant compressed blocks are decompressed, and the original log entries or requested portions thereof are reconstructed by decoding the field-specific encodings. This layered approach combines the benefits of field-level optimization with general compression efficiency, resulting in reduced storage requirements while maintaining accurate reconstruction and efficient query performance.

As an illustrative example, logs 140 are received from computing devices 110–112 by log storage computing system 120, with each log including event information generated during operation of the respective device. Upon receipt, log storage computing system 120 extracts a timestamp and a host identifier from each log and indexes the logs so that log entries from the same computing device and similar time periods are grouped together. After indexing, log storage computing system 120 identifies fields within each log, such as the timestamp, host identifier, and one or more additional fields, and compresses those fields using one or more field-specific compression techniques. The compressed field data is then arranged into data blocks, and a general compression operation is applied to each block to further reduce storage size by removing repeated byte patterns across multiple log entries. The compressed blocks are stored, and in some implementations, the original logs are deleted. When access to the logs is later required, the index is used to locate relevant compressed blocks, which are then decompressed to reconstruct the requested log entries.

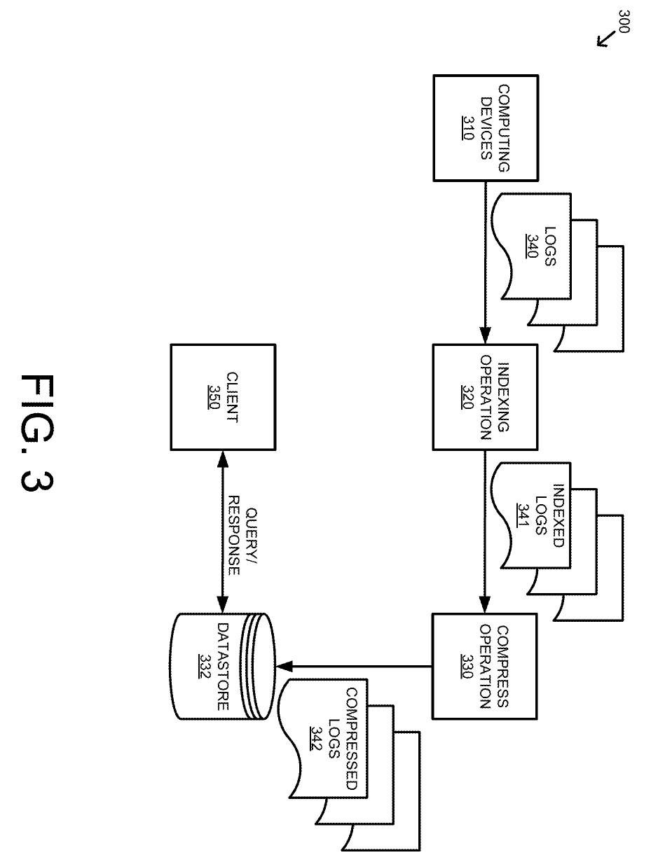

FIG. 3 illustrates an operational scenario 300 of performing compression on logs according to an implementation. Operational scenario 300 includes computing devices 310, indexing operation 320, compress operation 330, data store 332, logs 340, indexed logs 341, compressed logs 342, and client 350. One or more computing devices can perform indexing operation 320 and compress operation 330, including servers, desktop computers, or other computing devices.

In operational scenario 300, computing devices 310 generate logs 340 that are processed by indexing operation 320. Indexing operation 320 indexes logs 340 based on timestamp and host identifier to generate indexed logs 341. Indexed logs 341 represent organized log data based on when (timestamp) and where (host identifier or hostname) each log was generated. In some implementations, this assists in searching, filtering, and analyzing the data in the logs and further supports a reduced storage requirement for the logs after compression. After generating indexed logs 341, compress operation 330 is performed that generates compressed logs 342 that are stored in data store 332. In some implementations, compression can include Gzip (DEFLATE), Bzip2, or LZ4. In some cases, indexing logs by timestamp and host identifier can improve compression by grouping similar data points or attributes, enabling more efficient storage of repeated or sequential information. Specifically, when logs are organized by time and source, patterns in the data, such as recurring times and host identifiers, can be compressed more effectively, reducing storage space by reducing redundancies. Other pattern similarities in data can include the format, the types of data, or some other pattern.

Once the data is stored, clients, such as client 350, can query the log data and obtain responses. For example, a client device can generate a request for logs with attributes within a period. The logs can be retrieved from the data store using the indexing and compressing computing system, where the retrieved logs include the relevant attributes in the period. In some examples, by indexing the data before compression, a computing system can locate specific time ranges or host identifiers, reducing the amount of data that needs to be processed. This targeted access minimizes the computational overhead and speeds up the query response time, enabling more efficient analysis of log data.

In some implementations, in encoding or compressing the logs after indexing the logs, the full original document (e.g., JSON file) isn’t stored in the index. Instead, the software indexes only the necessary fields for searching and stores select fields or metadata associated with the file. This approach reduces storage space because the original content isn’t kept. Rather, the required information is stored in a compressed form. The compression codec can vary per field or metadata, depending on what is more efficient for the values associated with that field or metadata. For example, while a first field is compressed using a first codec, a second field can be compressed using a second codec. When a query is generated for the log, the software dynamically reconstructs the log by combining the stored fields based on the mappings. This way, the data remains accessible and searchable while minimizing storage requirements.

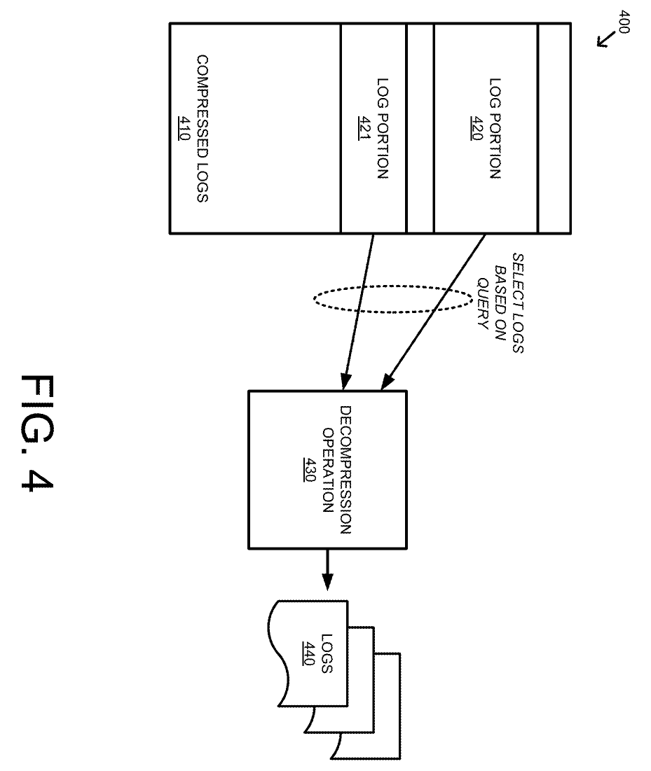

FIG. 4 illustrates an operational scenario 400 of processing log queries according to an implementation. Operational scenario 400 includes compressed logs 410, log portions 420 and 421, decompression operation 430, and logs 440. The processes of operational scenario 400 can be performed by a computing system, such as computing system 600.

In operational scenario 400, a system receives a query for a set of one or more logs. The query may specify conditions such as a time range, a source identifier, or one or more field values. Rather than examining all stored data, the system first evaluates the query against indexing and metadata associated with compressed logs 410. This indexing information identifies how the compressed logs are organized over time and across sources, allowing the system to quickly narrow the scope of data that must be accessed.

Based on this evaluation, the system determines which subsets of compressed logs 410 may contain log entries that satisfy the query. These subsets are identified as log portions 420 and 421. Each log portion represents a bounded segment of the compressed data, such as a segment associated with a particular time window or a group of logs sharing common indexed attributes. Log portions whose metadata indicates that they fall outside the query conditions are excluded from further processing. The identification of log portions 420 and 421 may rely on segment-level metadata stored alongside the compressed logs. This metadata may include minimum and maximum timestamp values for each segment, identifiers associated with logs in the segment, and pointers or offsets indicating where each segment is stored within compressed logs 410. By comparing query conditions to this metadata, the system selects only those portions that overlap the requested criteria.

After the relevant log portions are identified, the system can be configured to initiate decompression operation 430. Decompression operation 430 applies a general decompression step to each selected log portion, reversing the block-level or stream-level compression used during storage. This step expands the compressed byte sequences for log portions 420 and 421 into encoded representations of the stored log fields, without yet fully reconstructing the original log entries.

Following general decompression, decompression operation 430 performs field-level decoding on the decompressed data. Field-level decoding reverses field-specific compression techniques applied during storage, such as expanding dictionary-encoded values, reconstructing numeric values from delta or offset encodings, and restoring other compressed field representations. These decoding operations are applied to the selected log portions, which limits processing overhead.

As the fields are decoded, the system reconstructs logs 440 from the decoded data. Reconstructing a log includes assembling decoded field values into a logical log record that represents an original logged event. In implementations where the full original log document was not stored, logs 440 are generated dynamically using stored field values and predefined mappings that define how the fields are combined.

In some implementations, during or after reconstruction, the system may further filter the reconstructed logs to ensure that only log entries satisfying all query conditions are included in logs 440. For example, if a log portion contains entries that span a broader time range than requested, entries outside the specified range are excluded during reconstruction. This additional filtering ensures accurate query results while still benefiting from segment-level selection.

Once reconstruction and filtering are complete, logs 440 are provided as the response to the query. The response may include reconstructed log entries, partial log records that contain only requested fields, or a stream of log data suitable for analysis or display. By identifying log portions using metadata, selectively decompressing only relevant segments, and reconstructing logs on demand, the system efficiently handles log queries while minimizing data access, decompression work, and response time.

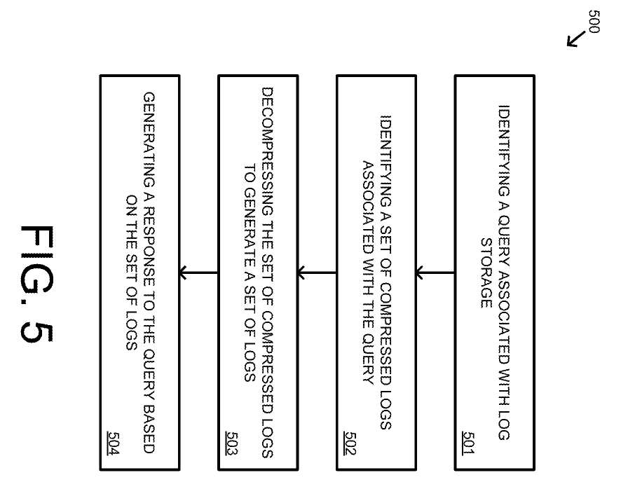

FIG. 5 illustrates a method 500 of providing responses to log queries according to an implementation. The steps of method 500 are referenced parenthetically in the paragraphs that follow. Method 500 can be performed by a computing system, such as computing system 600 of FIG. 6.

Method 500 includes identifying (501) a query associated with log storage. Method 500 further includes identifying (502) a set of compressed logs associated with the query and decompressing (503) the set of compressed logs to generate a set of logs. Method 500 further includes generating (504) a response to the query based on the set of logs.

In some implementations, step 501 begins when a computing system identifies a query associated with log storage from one or more computing devices. The query may be submitted by a user, an application, or an automated process and may include conditions such as a time range, a host identifier, a service name, or a severity level. In some examples, the system parses the query into a structured format so that each condition can be evaluated consistently. During step 501, the system may also validate the query parameters, for example, by confirming that the specified time range is valid or that the referenced log fields exist. When logs are stored as part of a time-ordered data stream, queries are interpreted relative to log events distributed across multiple storage segments. This early processing ensures the query is well-defined before accessing stored data.

At step 502, the system identifies a set of compressed log segments or portions that may contain log entries associated with the query. Log entries can be grouped and compressed into segments to reduce storage size. Each segment is associated with metadata, such as minimum and maximum timestamps and identifiers of the hosts or services represented in the segment. The system can be configured to compare the query conditions to this metadata and select only those segments that overlap with the requested criteria.

In some examples, the selection performed in step 502 avoids unnecessary processing by the system. For example, if the query requests error-level logs from a specific server during a ten-minute interval, only compressed segments whose metadata indicates they include that server and time range are selected. Segments that fall outside the query scope are excluded without being decompressed.

At step 503, the system can decompress the selected compressed log segments to restore the original log entries. Decompression reverses the compression process so that individual log fields, such as timestamps and message text, can be read and evaluated. In some implementations, decompression is performed incrementally, allowing the system to begin processing logs before an entire segment is fully decompressed.

At step 504, the system applies the query conditions to the decompressed log entries and generates a result. Log entries that do not satisfy the query filters are discarded, while those that do are retained. The resulting logs may be sorted, limited in number, or otherwise formatted before being returned or further processed. By combining selective segment identification, controlled decompression, and post-decompression filtering, the system efficiently retrieves relevant log data while minimizing resource usage. In some implementations, the result from step 504 can be presented to a user via a graphical user interface that displays the matching log entries in a structured, readable format. The logs may be shown as a time-ordered list or table with fields such as timestamp, source host, severity level, and message text, allowing the user to quickly understand system behavior. The interface may support pagination, sorting, or filtering to allow the user to navigate large result sets efficiently. In other implementations, the results may be returned as a machine-readable response, such as a JSON payload, that can be consumed by another application, exported for reporting, or used to trigger alerts or automated actions based on the contents of the retrieved logs.

FIG. 6 illustrates a computing system 600 for managing log compression according to an implementation. Computing system 600 represents any computing device or devices with which the various operational architectures, processes, scenarios, and sequences disclosed herein for managing compression of logs can be implemented. Computing system 600 is an example of log storage computing system 120 of FIG. 1. Computing system 600 includes storage system 645, processing system 650, communication interface 660, and input/output (I/O) device(s) 670. Processing system 650 is operatively linked to communication interface 660, I/O device(s) 670, and storage system 645. In some implementations, communication interface 660 and/or I/O device(s) 670 may be communicatively linked to storage system 645. Computing system 600 may further include other components, such as a battery and enclosure, which are not shown for clarity.

Communication interface 660 comprises components that communicate over communication links, such as network cards, ports, radio frequency, processing circuitry, software, or some other communication devices. Communication interface 660 may be configured to communicate over metallic, wireless, or optical links. Communication interface 660 may be configured to use Time Division Multiplex (TDM), Internet Protocol (IP), Ethernet, optical networking, wireless protocols, communication signaling, or some other communication format – including combinations thereof. Communication interface 660 may be configured to communicate with external devices, such as servers, client devices, or other computing devices.

I/O device(s) 670 may include peripherals of a computer that facilitate the interaction between the user and computing system 600. Examples of I/O device(s) 670 may include keyboards, mice, trackpads, monitors, displays, printers, cameras, microphones, external storage devices, sensors, and the like. I/O device(s) 670 can be omitted in some examples.

Processing system 650 comprises microprocessor circuitry (e.g., at least one processor) and other circuitry that retrieves and executes operating software (i.e., program instructions) from storage system 645. Storage system 645 may include volatile and nonvolatile, removable, and non-removable media implemented in any method or technology for storage of information, such as computer-readable instructions, data structures, program modules, or other data. Storage system 645 may be implemented as a single storage device but may also be implemented across multiple storage devices or sub-systems. Storage system 645 may comprise additional elements, such as a controller to read operating software from the storage systems. Examples of storage media (also referred to as computer-readable storage media) include random access, read-only memory, magnetic disks, optical disks, and flash memory, as well as any combination or variation thereof, or any other type of storage media. In some implementations, the storage media may be non-transitory. In some instances, at least a portion of the storage media may be transitory. In no case is the storage media a propagated signal.

Processing system 650 is typically mounted on a circuit board that may also hold the storage system. The operating software of storage system 645 comprises computer programs, firmware, or some other form of machine-readable program instructions. The operating software of storage system 645 comprises data store application 624. The operating software on storage system 645 may further include an operating system, utilities, drivers, network interfaces, applications, or some other type of software. When read and executed by processing system 650, the operating software on storage system 645 directs computing system 600 to implement the browser data store operations as described herein. In at least one implementation, the operating software can provide method 200 described in FIG. 2.

In at least one implementation, data store application 624 directs processing system 650 to obtain a plurality of logs from a plurality of computing devices. The computing devices can include servers, desktop computers, or others. The logs can include records that capture detailed events, actions, or messages generated by the system, applications, or users. They help track activities, errors, and system performance, often aiding in troubleshooting and security monitoring. As the logs are obtained, data store application 624 further directs processing system 650 to index the plurality of logs based on timestamps associated with the plurality of logs and host identifiers associated with the plurality of computing devices. Once indexed, data store application 624 directs processing system 650 to perform compression on the plurality of logs based on the indexing of the plurality of logs and store the compressed logs in a database or data store. Indexing the logs before compressing them improves storage efficiency by organizing the data for faster search and retrieval, allowing specific entries to be accessed without decompressing entire files. This can reduce the overall data volume by reducing redundancies, enabling more effective compression.

In some examples, data store application 624 can further process the queries to the compressed data store. Data store application 624 can direct processing system 650 to receive a query to the plurality of logs and generate a response based on the compression and the indexing of the plurality of logs. In some examples, by indexing the data before compression, a computing system can locate specific time ranges or host identifiers, reducing the amount of data that needs to be processed. This targeted access minimizes the computational overhead and speeds up the query response time, enabling more efficient log data analysis.

Below are example clauses associated with the present disclosure. The described clauses should not be considered exhaustive.

Clause 1. A method comprising: obtaining a plurality of logs from a plurality of computing devices; indexing the plurality of logs based on timestamps associated with the plurality of logs and host identifiers associated with the plurality of logs; and performing compression on the indexed plurality of logs.

Clause 2. The method of clause 1, wherein the plurality of computing devices comprises a plurality of servers.

Clause 3. The method of clause 1, wherein performing the compression on the indexed plurality of logs comprises: identifying one or more fields in the plurality of logs; and storing the one or more fields in one or more compressed formats.

Clause 4. The method of clause 3, wherein the one or more fields comprise a first field and a second field, wherein the one or more compressed formats comprise a first format and a second format, wherein the first field is compressed in the first format, and wherein the second field is compressed in the second format.

Clause 5. The method of clause 3 further comprising: deleting the plurality of logs in response to storing the one or more fields.

Clause 6. The method of clause 3 further comprising: in response to a request for a log in the plurality of logs, regenerating the log from the one or more fields stored in the one or more compressed formats.

Clause 7. The method of clause 1 further comprising: receiving a query to the plurality of logs; and generating a response to the query based on the compression and the indexed plurality of logs.

Clause 8. A computing system comprising: at least one processor; a computer-readable storage medium operatively coupled to the at least one processor; and program instructions stored on the computer-readable storage medium that, when executed by the at least one processor, direct the computing system to perform a method, the method comprising: obtaining a plurality of logs from a plurality of computing devices; indexing the plurality of logs based on timestamps associated with the plurality of logs and host identifiers associated with the plurality of logs; and performing compression on the indexed plurality of logs.

Clause 9. The computing system of clause 8, wherein the plurality of computing devices comprises a plurality of servers.

Clause 10. The computing system of clause 8, wherein performing the compression on the indexed plurality of logs comprises: identifying one or more fields in the plurality of logs; and storing the one or more fields in one or more compressed formats.

Clause 11. The computing system of clause 10, wherein the one or more fields comprise a first field and a second field, wherein the one or more compressed formats comprise a first format and a second format, wherein the first field is compressed in the first format, and wherein the second field is compressed in the second format.

Clause 12. The computing system of clause 10, wherein the method further comprises: deleting the plurality of logs in response to storing the one or more fields.

Clause 13. The computing system of clause 10, wherein the method further comprises: in response to a request for a log in the plurality of logs, regenerating the log from the one or more fields stored in the one or more compressed formats.

Clause 14. The computing system of clause 8, wherein the method further comprises: receiving a query to the plurality of logs; and generating a response to the query based on the compression and the indexed plurality of logs.

Clause 15. A computer-readable storage medium having program instructions stored thereon that, when executed by at least one processor, direct the at least one processor to perform a method, the method comprising: obtaining a plurality of logs from a plurality of computing devices; indexing the plurality of logs based on timestamps associated with the plurality of logs and host identifiers associated with the plurality of logs; and performing compression on the indexed plurality of logs.

Clause 16. The computer-readable storage medium of clause 15, wherein performing the compression on the indexed plurality of logs comprises: identifying one or more fields in the plurality of logs; and storing the one or more fields in one or more compressed formats.

Clause 17. The computer-readable storage medium of clause 16, wherein the one or more fields comprise a first field and a second field, wherein the one or more compressed formats comprise a first format and a second format, wherein the first field is compressed in the first format, and wherein the second field is compressed in the second format.

Clause 18. The computer-readable storage medium of clause 16, wherein the method further comprises: deleting the plurality of logs in response to storing the one or more fields.

Clause 19. The computer-readable storage medium of clause 16, wherein the method further comprises: in response to a request for a log in the plurality of logs, regenerating the log from the one or more fields stored in the one or more compressed formats.

Clause 20. The computer-readable storage medium of clause 15, wherein the method further comprises: receiving a query to the plurality of logs; and generating a response to the query based on the compression and the indexed plurality of logs.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that, when executed, cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. They have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitively indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method comprising:
obtaining a plurality of logs from a plurality of computing devices;
indexing the plurality of logs based on timestamps associated with the plurality of logs and host identifiers associated with the plurality of logs; and
performing compression on the indexed plurality of logs.

2. The method of claim 1, wherein the plurality of computing devices comprises a plurality of servers.

3. The method of claim 1, wherein performing the compression on the indexed plurality of logs comprises:
identifying one or more fields in the plurality of logs; and
storing the one or more fields in one or more compressed formats.

4. The method of claim 3, wherein the one or more fields comprise a first field and a second field, wherein the one or more compressed formats comprise a first format and a second format, wherein the first field is compressed in the first format, and wherein the second field is compressed in the second format.

5. The method of claim 3 further comprising:
deleting the plurality of logs in response to storing the one or more fields.

6. The method of claim 3 further comprising:
in response to a request for a log in the plurality of logs, regenerating the log from the one or more fields stored in the one or more compressed formats.

7. The method of claim 1 further comprising:
receiving a query to the plurality of logs; and
generating a response to the query based on the compression and the indexed plurality of logs.

8. A computing system comprising:
at least one processor;
a computer-readable storage medium operatively coupled to the at least one processor; and
program instructions stored on the computer-readable storage medium that, when executed by the at least one processor, direct the computing system to perform a method, the method comprising:
obtaining a plurality of logs from a plurality of computing devices;
indexing the plurality of logs based on timestamps associated with the plurality of logs and host identifiers associated with the plurality of logs; and
performing compression on the indexed plurality of logs.

9. The computing system of claim 8, wherein the plurality of computing devices comprises a plurality of servers.

10. The computing system of claim 8, wherein performing the compression on the indexed plurality of logs comprises:
identifying one or more fields in the plurality of logs; and
storing the one or more fields in one or more compressed formats.

11. The computing system of claim 10, wherein the one or more fields comprise a first field and a second field, wherein the one or more compressed formats comprise a first format and a second format, wherein the first field is compressed in the first format, and wherein the second field is compressed in the second format.

12. The computing system of claim 10, wherein the method further comprises:
deleting the plurality of logs in response to storing the one or more fields.

13. The computing system of claim 10, wherein the method further comprises:
in response to a request for a log in the plurality of logs, regenerating the log from the one or more fields stored in the one or more compressed formats.

14. The computing system of claim 8, wherein the method further comprises:
receiving a query to the plurality of logs; and
generating a response to the query based on the compression and the indexed plurality of logs.

15. A computer-readable storage medium having program instructions stored thereon that, when executed by at least one processor, direct the at least one processor to perform a method, the method comprising:
obtaining a plurality of logs from a plurality of computing devices;
indexing the plurality of logs based on timestamps associated with the plurality of logs and host identifiers associated with the plurality of logs; and
performing compression on the indexed plurality of logs.

16. The computer-readable storage medium of claim 15, wherein performing the compression on the indexed plurality of logs comprises:
identifying one or more fields in the plurality of logs; and
storing the one or more fields in one or more compressed formats.

17. The computer-readable storage medium of claim 16, wherein the one or more fields comprise a first field and a second field, wherein the one or more compressed formats comprise a first format and a second format, wherein the first field is compressed in the first format, and wherein the second field is compressed in the second format.

18. The computer-readable storage medium of claim 16, wherein the method further comprises:
deleting the plurality of logs in response to storing the one or more fields.

19. The computer-readable storage medium of claim 16, wherein the method further comprises:
in response to a request for a log in the plurality of logs, regenerating the log from the one or more fields stored in the one or more compressed formats.

20. The computer-readable storage medium of claim 15, wherein the method further comprises:
receiving a query to the plurality of logs; and
generating a response to the query based on the compression and the indexed plurality of logs.
